(19) United States
(12) Patent Application Publication
(10) Pub. No.: US 2020/0292870 A1
(43) Pub. Date: Sep. 17, 2020

(54) DISPLAY DEVICE

(71) Applicant: SHARP KABUSHIKI KAISHA, Sakai City (JP)

(72) Inventor: AKIRA KAWANO, Sakai City (JP)

(21) Appl. No.: 16/807,921

(22) Filed: Mar. 3, 2020

Related U.S. Application Data
(60) Provisional application No. 62/818,719, filed on Mar. 14, 2019.

(51) Int. Cl. G02F 1/1333; G02F 1/1335

(52) U.S. Cl. CPC G02F 1/133308; G02F 2001/133317; G02F 1/133512

(57) ABSTRACT

A display device includes a display panel, a backlight unit, and a fixing member. The display panel includes a display area in which images are displayed and a non-display area disposed to surround the display area. The backlight unit is disposed opposite a back surface of the display panel. The fixing member is fixed between the display panel and the backlight unit to fix the display panel and the backlight together. The fixing member includes a light blocking portion having a light blocking property and a light passing portion having light transmissivity. The light blocking portion is disposed in an area overlapping the non-display area. The light passing portion is disposed inner than the light blocking portion.

### CROSS REFERENCE TO RELATED APPLICATION

This application claims priority from U.S. Provisional Patent Application No. 62/818,719 filed on Mar. 14, 2019. The entire contents of the priority application are incorporated herein by reference.

### TECHNICAL FIELD

The technology described herein relates to a display device.

### BACKGROUND

A thin display device in a flat shape for an electronic product includes at least a display panel for displaying images and a backlight unit for applying light to the display panel from a back side. A method for fixing the display panel and the backlight unit together may use an adhesive double-sided tape. The double-sided tape is attached to a frame-shaped outer edge area of the display panel corresponding to a non-display area. The double-sided tape is provided in black to have a light blocking property to block light to the non-display area NAA.

As a reduction in frame width progresses in recent years, structural difficulty arises to reserve a sufficient area for the double-sided tape. An increase in retention force is expected.

### SUMMARY

The technology described herein was made in view of the above circumstances. An object is to provide a display device including a display panel and a backlight unit solidly fixed together.

A display device includes a display panel, a backlight unit, and a fixing member. The display panel includes a display area. in which images are displayed and a non-display area disposed to surround the display area. The backlight unit is disposed opposite a back surface of the display panel. The fixing member is fixed between the display panel and the backlight unit to fix the display panel and the backlight together. The fixing member includes a blocking portion and a light passing portion. The light blocking portion has a light blocking property. The light blocking portion is disposed in an area overlapping the non-display area. The light passing portion has light transmissivity. The light passing portion is disposed inner than the light blocking portion.

According to the technology described herein, a display device including a display panel and a backlight unit solidly fixed together.

### BRIEF DESCRIPTION OF THE DRAWINGS

FIG. 1 is an exploded perspective view of a liquid crystal display device according to an embodiment.

FIG. 2 is a cross-sectional side view of the liquid crystal display device.

FIG. 3 is a plan view of a fixing sheet.

FIG. 4 is a cross-sectional side view of the fixing sheet.

FIG. 5 is a plan view of a fixing member according to another embodiment.

### DETAILED DESCRIPTION

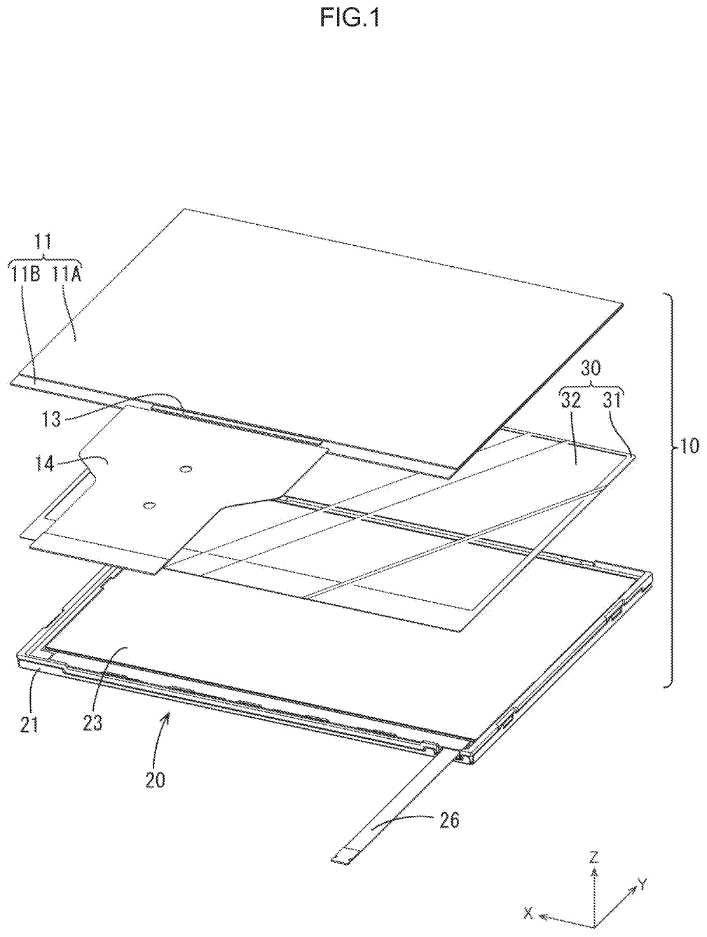

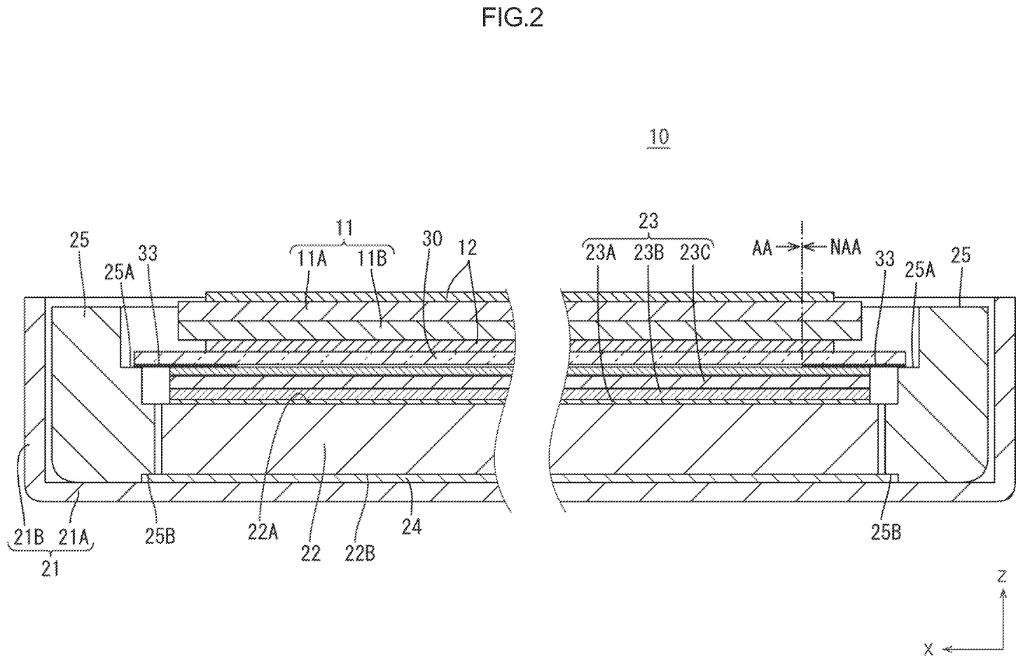

An embodiment will be described in detail with reference to FIGS. 1 to 4. In this section, a liquid crystal display device 10 (an example of a display device) including a liquid crystal panel 11 will be described. In the drawings, X-axes, Y-axes, and Z-axes may be present. The axes in each drawing correspond to the respective axes in other drawings. A vertical direction is defined based on FIG. 2. An upper side and a lower side in FIG. 2 correspond to a front side and a rear side of the liquid crystal display device 10, respectively.

The liquid crystal display device 10 has a block shape with a rectangular shape in a plan view. As illustrated in FIG. 1, the liquid crystal display device 10 includes the liquid crystal panel 11 and a backlight unit 20. The liquid crystal panel 11 is formed in a plate shape and configured to display images. The backlight unit 20 is disposed behind the liquid crystal panel 11 and configured to apply light to the liquid crystal panel 11. The liquid crystal display device 10 according to this embodiment may be used for an electronic device such as a portable digital assistant (e.g., a mobile phone, a smartphone, and a tablet personal computer), an onboard digital assistant a built-in car navigation system and a portable car navigation system), and a handheld gate console.

The liquid crystal panel 11 has a rectangular plate shape. The liquid crystal panel 11 has a known configuration including a pair of transparent glass substrates (having high transmissivity) 11A and 11B and a liquid crystal layer. The glass substrates 11A and 11E are bonded together with a predefined gap therebetween. The liquid crystal layer is disposed between the glass substrates 11A and 11B.

On the glass substrate 11A on the front side, color filters, a common electrode, and an alignment film are disposed. The color filters include red (R), green (C), and blue (B) color portions arranged in predefined sequence. On the glass substrate 11B on the back side, switching components (e.g., TFTs) connected to source lines and gate lines that are perpendicular to each other, pixel electrodes connected to the switching components, and an alignment film are disposed. Image data and various control signals are transmitted from a driver circuit board to the source lines, the gate lines, and the common electrode for displaying images.

The glass substrate 11B of the pair of glass substrates 11A and 11B on the back side has a short dimension larger than a short dimension of the glass substrate 11A on the front side. The glass substrate 11B is bonded to the glass substrate 11A with one of edges at an end of the short dimension (on the upper side in FIG. 1) aligned with that of the glass substrate 11A. Front and back surfaces of section of the glass substrate 11B including the other edge at an end of the short dimension (on the lower side in FIG. 1) is exposed without the glass substrate 11A thereon. A driver 13 for driving the liquid crystal panel 11 is mounted on the section of the glass substrate 11B.

Polarizing plates 12 are disposed on outer surfaces (a front surface and a back surface) of the glass substrates 11A and 11B. Each of the polarizing plates 12 has a sheet shape slightly smaller than an overall size of the glass substrates 11A and 11B. The polarizing plates 12 cover the outer surfaces of the glass substrates 11A and 11B such that edge areas of the front surface and the back surface of the liquid crystal panel 11 in frame shapes are exposed. The polarizing plates 12 are components of the liquid crystal panel 11.

The liquid crystal panel 11 includes a display area (an active area) AA and a non-display area (a non-active area) NAA. The display area AA is located. closer to a first long edge (on the upper side in FIG. 1) extending in a lengthwise direction (the X-axis direction). The non-display area NAA is a frame-shaped area surrounding the display area AA and in which images are not displayed. A section of the non-display area NAA along a second long edge (on the lower side in FIG. 1) has a width larger than widths of other sections. The driver 13 is mounted on the wide section and a flexible circuit board 14 that is connected to a control circuit board is connected to the wide section.

The liquid crystal panel 11 is configured to display images using light supplied by the backlight unit 20. A front side of the liquid crystal panel 11 is defined as a fight exiting side. The lengthwise direction and the widthwise direction of the liquid crystal panel 11 correspond with the X-axis direction and the Y-axis direction, respectively. Further, a thickness direction of the liquid crystal panel 1 corresponds with the Z-axis direction.

The backlight unit 20 has a block shape with a rectangular shape in a plan view. The backlight unit 20 includes a chassis 21, light emitting diodes (LEDs), an LED substrate, a light guide plate 22, an optical sheet 23, a reflection sheet 24, and a pair of holders 25. The chassis 21 has a box shape with an opening on a liquid crystal panel 11 side. The LEDs are light sources and mounted on the LED substrate. The light guide plate 22 is configured to guide light emitted by the LEDs. The optical sheet 23 is stacked on a front surface of the light guide plate 22. The reflection sheet 24 is stacked on a back surface of the light guide plate 22. The holders 25 are disposed along short edges of the chassis 21.

In the backlight unit 20, the LEDs are disposed at an end surface of the light guide plate 22 on one of long edge sides (on the lower side in FIG. 1 and light enters the light guide plate 22 from one side. That is, the backlight unit 20 is a one-side edge-lit (a side-lit) backlight. The backlight unit 20 is configured to convert the light from the LEDs into planar light and output the light toward the liquid crystal panel 11 on the front side through the opening of the backlight unit 20. The front side of the backlight unit 20 is defined as the light exiting side. The components of the backlight unit 20 will be described in sequence.

The chassis 21 is made of a metal material such as an aluminum sheet and an electro galvanized sheet (SECC). The chassis 21 has a rectangular shape in a plan view and a box shape with the opening on the front side. The chassis 21 holds the LED substrate and the light guide plate 22 therein (see FIG. 2). The chassis 21 includes a bottom plate 21A and sidewalls 21B. The bottom plate 21A has a rectangular shape. The sidewalls 21B project from edges (two long edges and two short edges) of the bottom plate 21A toward the front side, respectively. A lengthwise direction and a widthwise direction of the bottom plate 21A of the chassis 21 correspond with the X-axis direction and the Y-axis direction, respectively direction perpendicular to the plate surface of the bottom plate 21A corresponds with the Z-axis direction.

The bottom plate 21A supports the components held in the chassis 21 from the back side. The sidewalls 21B are disposed to surround the components held in the chassis 21 from outer sides, that is, the sidewalls 21B form a rectangular frame.

Each of the LEDs includes an LED chip (a LED component) disposed on a substrate fixed to a plate surfaced of the LED substrate and sealed by a resin material. The LED chip mounted on the substrate is configured to emit light with one main emission wavelength, specifically, in single color of blue. The rein material that seals the LED chip contains phosphors dispersed in a resin. The phosphors are configured to emit light in a specific color when exited. by the blue light emitted by the LED chip. The phosphors are configured to emit light in substantially white.

The LED substrate includes a base film, conductive lines, a thermoplastic layer, and the LEDs. The base film is made of thermosetting resin such as a urethane resin and an epoxy resin. The conductive lines are patterned on the base film for supplying power to the LEDs. The thermoplastic layer having a thermoplastic property such as a polyimide resin is stacked on the base film. The LEDs arranged at intervals are surface-mounted on the thermoplastic layer.

The LED substrate is disposed along an inner surface of the sidewall 21B of the chassis 21 such that light emitting surfaces of the LEDs are opposed to and parallel to the end surface of the light guide plate 22, which will be described later, on the long edge side. The LED substrate includes a base portion. and an external circuit connecting portion 26. The base portion has an elongated band shape and a long dimension (a dimension in the X-axis direction) about equal to a long dimension of the light guide plate, which will be described later. The external circuit connecting portion 26 extend from the base portion in the vertical direction (the Y-axis direction). The external circuit connecting portion 26 is connected to an external circuit. The external circuit connecting portion 26 is drawn out of the chassis 21 through a cutout in the sidewall 21B. The LEDs are arranged in line on the base portion having the band shape and mounted on the base portion.

The light guide plate 22 is made of a transparent synthetic resin such as an acrylic-based resin and a polycarbonate. The light guide plate 22 has a rectangular plate shape slightly smaller than the bottom plate 21A of the chassis 21 in a plan view. The light guide plate 22 is disposed parallel to the bottom plate 21A of the chassis 21. The lengthwise direction and the widthwise direction of the light guide plate 22 correspond with the X-axis direction and the Y-axis direction, respectively. The thickness direction of the light guide plate 22 perpendicular to the plate surface of the light guide plate 22 corresponds with the Z-axis direction. The light guide plate 22 is held in the chassis 21 to be surrounded by the sidewalls 21B.

An upper surface (a front surface) of a pair of plate surfaces of the light guide plate is defined as a light exiting surface 22A through which light that has entered the light guide plate 22 exits toward the liquid crystal panel 11. The optical sheet 23 is stacked on the light exiting surface 22A.

The optical sheet 23 is a rectangular flat sheet. The lengthwise direction and the widthwise direction of the optical sheet 23 correspond with the X-axis direction and the Y-axis direction, respectively. The optical sheet 23 is disposed immediately behind the liquid crystal panel. The optical sheet 23 is disposed between the light guide plate 22 and the liquid crystal panel 11. The optical sheet 23 passes the from the light guide plate 22, exerts predefined optical effects on the passing light, and directs the light to the liquid crystal panel 11.

The optical sheet 23 in this embodiment has a triple-layer structure. The optical sheet 23 includes a diffuser sheet 23A, a lens sheet 23B, and a reflective polarizing sheet 23C stacked in this sequence from a lower layer side.

The reflection sheet 24 is stacked on the back surface of the light guide late 22. The reflection sheet 24 is made of a synthetic resin sheet material having a white surface with high light reflectivity. The reflection sheet 24 efficiently direct light rays traveling through the light guide plate 22 and exiting through a reflective surface 22B on an opposite side from the light exiting surface 22A toward the front side (the light exiting surface 22A). The reflection sheet 24 has a rectangular shape in a plan view. A large area of a middle portion of the reflection sheet 24 is sandwiched between the light guide plate 22 and the bottom plate 21A of the chassis 21. Edge sections of the reflection sheet 24 project outer than the outer end surfaces of the light guide plate 22.

The holders 25 are made of a white synthetic resin. Each holder 25 has an elongated square bar shape extending in the widthwise direction of the chassis 21 (the Y-axis direction). The holders 25 are disposed inside the chassis 21 along the sidewalls 21B adjacent to the short edges of the chassis 21. Upper inner edges of the holders 25 are cut such that each holder 25 has an L shaped edge in a cross-sectional view to form receiving portions 25A on which edge sections of the fixing sheet 30, which will be described later, can be placed, respectively. Lower inner edges of the holders 25 are cut such that each holder 25 has an L shaped edge in a cross-sectional view to form pressing portions 25B with which the edge sections of the reflection sheet 24 projecting from the edges of the light guide plate 22 are pressed toward the chassis 21.

The liquid crystal panel 11 is fixed to the backlight unit 20 with the fixing sheet 30 (an example of the fixing member), which will be described next.

The fixing sheet 30 is made of a synthetic resin. The fixing sheet 30 includes a base having a sheet shape slightly larger than the liquid crystal panel 11 and adhesives applied to surfaces of the base. The base of the fixing sheet 30 is made of a material having highlight transmissivity such as a polycarbonate or an acrylic resin. The adhesives applied to the surfaces of the base may be acrylic-based adhesives, urethane-based adhesives, or silicone-based adhesives having high light transmissivity. The acrylic-based adhesives may be preferred to other the adhesives because polymers thereof have high tackiness and because of their high modifiability, high resistance to heat and weather, and high adherend selectivity.

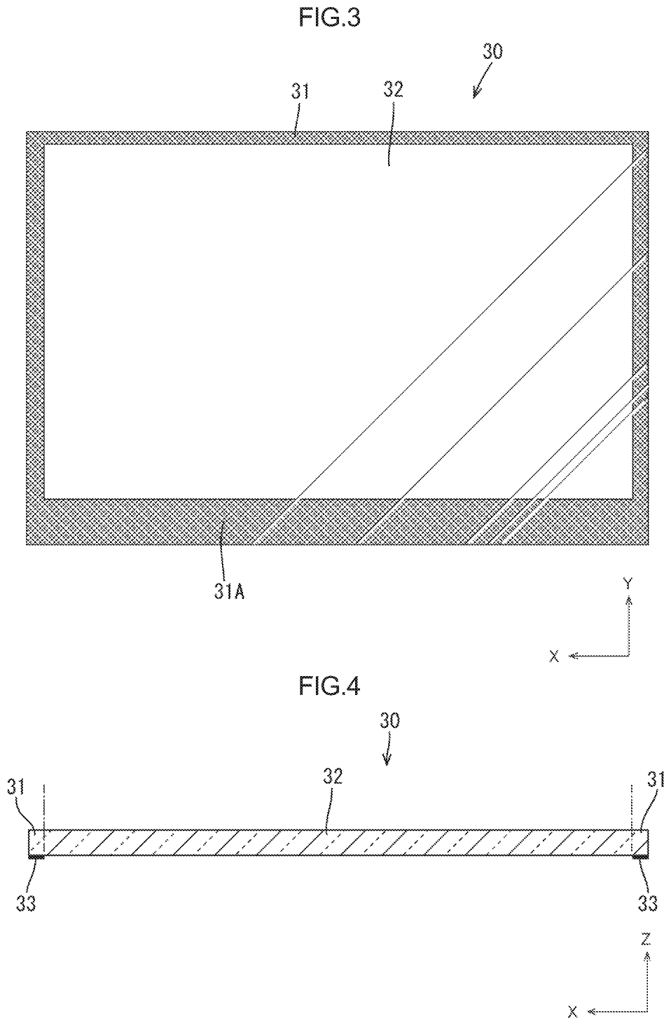

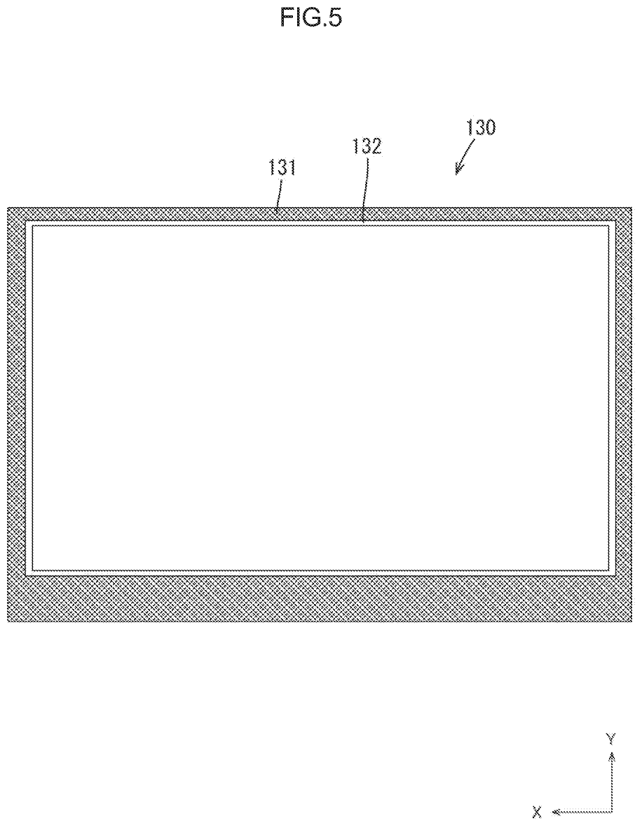

A light blocking portion 31 that does not pass the light is provided in an outer edge portion, that is, a frame-shaped region of the fixing sheet 30 including section overlapping the non-display area (NAA) of the liquid crystal panel 11. The light blocking portion 31 includes a light blocking layer 33 having a light blocking property printed on the back surface (a surface on a backlight unit 20 side) of the base of the fixing sheet 30 (see FIG. 4). A portion of the fixing sheet 30 in which the light blocking layer 33 is not provided inner than the light blocking portion 31 is defined as a light passing portion 32 having light transmissivity (see FIG. 3).

As illustrated in FIG. 2, the outer edge portion (the light blocking portion 31) of the fixing sheet 30 that is attached to a predefined attachment position on the back surface of the liquid crystal panel 11 projects slightly outer than the outer edges of the liquid crystal panel 11. The light blocking portion 31 of the fixing sheet 30 that is attached to a predefined attachment position on the back surface of the liquid crystal panel 11 extends inner than the edges of the liquid crystal panel 11 to overlap the non-display area NAA of the liquid crystal panel 11.

The liquid crystal display device 10 according to this embodiment has the configuration described above. Operation and Effect of the liquid crystal display device 10 will be described.

The liquid crystal display device 10 according to this embodiment includes the liquid crystal panel 11, the backlight unit 20, and the fixing sheet 30. The liquid crystal panel 11 includes the display area AA in which images are displayed and the non-display area NAA surrounding the display area. The backlight unit 20 is disposed opposite the back surface of the liquid crystal panel 11. The fixing sheet 30 is fixed between the liquid crystal panel 11 and the backlight unit 20 to fix the liquid crystal panel 11 and the backlight unit 20 together. The fixing sheet 30 includes the light blocking portion 31 and the light passing portion 32. The light blocking portion 31 is disposed in the area overlapping the non-display area NAA. The light passing portion 32 having the light transmissivity is disposed inner than the light blocking portion 31.

According to the configuration, the fixing sheet 30 includes joint plane areas larger than the non-display area NAA regardless of an area of the non-display area NAA. Therefore, high cohesion (a large retention force) can be achieved. Further, leakage of light from the edges of the display area AA is reduced by the light blocking portion 31.

The light passing portion 32 entirely covers the display area AA. According to the configuration, higher cohesion (a larger retention force) can be achieved.

The light blocking portion 31 includes the light blocking layer 33 printed on one of the surfaces of the base light having the transmissivity. According to the configuration, the fixing sheet 30 including the light blocking portion 31 and the light passing portion 32 that are integrally provided can be prepared by a simple method that includes printing the light blocking layer 33 at the predefined position on the base sheet having high light transmissivity.

### Other Embodiments

The technology described herein is not limited to the embodiments described above and illustrated by the drawings. For example, the following embodiments will be included in the technical scope of the technology described herein.

(1) In the above embodiment, the edge sections of the fixing sheet 30 for fixing the liquid crystal panel 11 and the backlight unit 20 together are placed on the receiving portions 25A of the holders 25 in the backlight unit 20 and fixed. However, the configuration of the backlight unit 20 is not limited to the configuration in the above embodiment and may be altered where appropriate. The edge sections of the fixing sheet may be fixed to components other than the holders as long as the liquid crystal panel 11 and the backlight unit 20 are fixed together with fixing members having adhesiveness.

(2) In the above embodiment, the fixing sheet 30 covers the entire area of the liquid crystal panel 11. However, the fixing sheet 30 may not cover the entire area of the liquid crystal panel 11. For example, a fixing member having a frame shape illustrated in FIG. 5 may be provided. The fixing member 130 includes a light blocking portion 131 and a light passing portion 132. The light blocking portion 131 has a frame shape to overlap the non-display area NAA. The light passing portion 132 has a frame shape to extend inwardly from the light blocking portion 131. According to such a configuration, an area of the liquid panel and an area of the backlight unit 20 bonded together are larger than the non-display area NAA. Therefore, cohesion (a retention force) increases.

(3) In the above embodiment, the light blocking portion 31 of the fixing sheet 30 is disposed in areas between the outer edges of the liquid crystal panel 11 and borders between. the non-display area NAA and the display area AA. However, the areas may be altered as long as the light blocking portion is not disposed in the display area AA because a sufficient fixing area can be provided by the light passing portion.

1. A display device comprising:
a display panel including a display area in which images are displayed and a non-display area disposed to surround the display area;
a backlight unit disposed opposite a back surface of the display panel; and
a fixing member fixed between the display panel and the backlight unit to fix the display panel and the backlight together, the fixing member including:
a light blocking portion having a light blocking property and being disposed in an area overlapping the non-display area; and
a light passing portion having light transmissivity and being disposed inner than the light blocking portion.

2. The display device according to claim 1, wherein the light passing portion entirely covers the display area.

3. The display device according to claim 1, wherein the light blocking portion includes alight blocking layer printed on one of surfaces of a base having light transmissivity.
